(19) United States
(12) Patent Application Publication
(10) Pub. No.: US 2019/0069977 A1
(43) Pub. Date: Mar. 7, 2019

(54) ARRANGEMENT OF AN ATTACHMENT ELEMENT ON AN IMPLANT BODY

(71) Applicant: Champions-Implants GmbH, Flonheim (DE)

(72) Inventor: Norbert Bomba, Wiesbaden (DE)

(73) Assignee: Champions-Implants GmbH, Flonheim (DE)

(21) Appl. No.: 16/120,246

(22) Filed: Sep. 1, 2018

(30) Foreign Application Priority Data
Sep. 2, 2017 (DE) 102017008261.8

(51) Int. Cl. A61C 8/00

(52) U.S. Cl. CPC A61C 8/0077

(57) ABSTRACT

Disclosed herein are embodiments of dental implant arrangements comprising an implant body and an attachment element, wherein the implant body is designed matching the attachment element in such a way that the attachment element is partially insertable into the implant body as far as an abutment surface on the implant body. The attachment element is connected to the implant body by a connection element and is characterized in that an attachment element abutment surface of the attachment element is held against the abutment surface by the connection element. The implant body has a first sealing surface, which is located opposite a second sealing surface of the attachment element. The first sealing surface or the second sealing surface has a sealing seat into which a sealing element is inserted by which the interior of the implant body is sealed off from the environment.

### CROSS REFERENCE TO RELATED APPLICATIONS

This application claims priority from German Patent Application No. 10 2017 008 261.8, filed Sep. 2, 2017, entitled “Anordnung von einen Aufsatzelement auf einem Implantatkörper”, the entire contents of which are incorporated herein by reference.

### TECHNICAL FIELD

The present embodiments generally relate to dental implants.

### BACKGROUND

It is generally known to screw an implant body with the aid of a tool into the jaw bone of a human in order to replace missing dental roots. After insertion of the implant body into the jaw bone, the implant body is usually closed by a cover screw in order to prevent entry of microorganisms. The arrangement of implant body and cover screw remains in the jaw of the patient for a certain time without further working, so as to allow the jaw bone to fuse with the implant body. Later, the cover screw is detached from the implant body and, in its place, a gingiva former is fitted onto the implant body. The gingiva former is intended to prepare the gum to receive a tooth replacement. The gingiva former is usually adapted in shape to the tooth replacement that is later to be fitted, and it provides a corresponding shaping of the gum. At a further treatment session, an impression is taken. For this purpose, the gingiva former is replaced by an impression post. Thus, the position of the subsequent tooth replacement in the jaw can be simulated in the dental laboratory, and the tooth replacement can be prepared for fitting onto the implant body. At a further session, the tooth replacement prepared in the laboratory is fitted in place. For this purpose, an abutment structure is initially fitted onto the screwed-in implant body and is anchored in the implant body, preferably screwed into the implant body. In a final work step, the artificial tooth replacement is lastly mounted on the abutment structure. In the preceding work steps, particular care is taken to ensure that entry of microorganisms into the interior of the implant body is avoided.

In this regard, the various attachments provided for introduction into the implant body are screwed into the latter only as far as a predefinable depth. For this purpose, an abutment with an abutment surface is fitted on the implant body, as far as which surface a corresponding surface of an attachment is screwed. In this way, the attachment sits at a structurally predefined position.

In order to improve the sealing action at the abutment surface between an implant body and an extension bushing and thereby more safely avoid entry of microorganisms, EP 0 893 105 B1 proposes placing a flat seal at the abutment surface between the implant body and the extension bushing. A disadvantage of this is that the sealing force acts only in the axial direction and, in addition, the axial position of the attachment relative to the implant body is changed by the interposition of the flat seal. Moreover, the axial position of the attachment may change in an undesirable and disadvantageous manner depending on the torque that is applied to screw the attachment against the seal and the implant body.

Therefore, it is desirable to provide an arrangement of an implant body and an attachment element which predefines the axial position of the attachment element relative to the implant body as precisely as possible and which additionally has an excellent sealing action.

### BRIEF DESCRIPTION OF THE DRAWINGS

In the accompanying drawings, structures are illustrated that, together with the detailed description provided below, describe exemplary embodiments of the claimed apparatus. The drawings are provided for purpose of illustration only and merely depict aspects of typical or example embodiments. These drawings are provided to facilitate the reader's understanding of the disclosure and shall not be considered limiting of the breadth, scope, or applicability of the disclosure.

The elements in the drawing are not necessarily drawn to scale and the proportion of certain elements may be exaggerated for the purpose of illustration. In the drawings, like reference numerals designate corresponding elements throughout the several views. One of ordinary skill in the art will appreciate that elements shown as a single component may be replaced with multiple components, and elements shown as multiple components may be replaced with a single component.

FIG. 1 is a schematic drawing illustrating a side elevational view of one embodiment of an arrangement according to the embodiments described herein, comprising an implant body and a gingiva former, which can be connected to each other by a fastening screw, wherein an impression post is also shown which can be connected to the gingiva former.

FIG. 2 is a schematic drawing illustrating a side elevational view of the arrangement according to FIG. 1, in the assembled state.

FIG. 3 is a schematic drawing illustrating a side sectional view of the implant body of the arrangement according to FIGS. 1 and 2 with O-ring.

FIG. 4 is a schematic drawing illustrating a side partial sectional view of the gingiva former of the arrangement according to FIGS. 1 and 2 with a first wedge-shaped sealing ring.

FIG. 5 is a schematic drawing illustrating a side sectional view of the implant body of the arrangement according to FIGS. 1 and 2 with a second wedge-shaped sealing ring.

FIG. 6 is a schematic drawing illustrating a side sectional view of an arrangement comprising an implant body and, screwed onto the latter, an abutment structure with an O-ring.

FIG. 7 is a schematic drawing illustrating a side elevational view of a second abutment structure with O-ring.

FIG. 8 is a schematic drawing illustrating a side sectional view of an example of an implant body with a third wedge-shaped sealing ring.

### DETAILED DESCRIPTION

It should be understood that aspects, features or functions that are described in relation to an embodiment are not necessarily limited to the embodiment described, but rather may be applicable to one or more embodiments, unless expressly described otherwise. Also, the description set forth herein is not to be construed as limited to the embodiments shown. Rather, it is appreciated that various modifications may occur to those skilled in the art that, while not specifically set forth herein, are nevertheless within the spirit and scope of the description. When an embodiment is described as “exemplary” herein, it is to be understood as one non-limiting example embodiment and does not preclude other embodiments that may not include the limitations described in the exemplary embodiment.

The present disclosure describes and illustrates one or more novel embodiments of a dental implant arrangement comprising an implant body and an attachment element, wherein the implant body is designed matching the attachment element in such a way that the attachment element is partially insertable into the implant body as far as an abutment surface on the implant body, wherein the attachment element is connected to the implant body by a connection element.

In particular, the present disclosure describes and illustrates one or more novel embodiments of a dental implant arrangement comprising an implant body and an attachment element, wherein the implant body is designed matching the attachment element in such a way that the attachment element is partially insertable into the implant body as far as an abutment surface on the implant body (i.e., implant body abutment surface), wherein the attachment element is connected to the implant body by a connection element, and an abutment surface on the attachment element (i.e., attachment element abutment surface) is held against the implant body abutment surface by the connection element, wherein the implant body has a first sealing surface, which is located opposite a second sealing surface of the attachment element, and wherein the first sealing surface or the second sealing surface has a sealing seat into which a sealing element is inserted by which the interior of the implant body is sealed off from the environment.

In the one or more embodiments described herein, the abutment and the seal may be arranged at different locations. By inserting the attachment element into the implant body as far as the abutment on the implant body allows, the attachment element is positioned exactly at a structurally predefined location. The attachment element abutment surface and the implant body abutment surface touch each other directly, i.e. without the interposition of a further component, for example a seal. In this way, the axial position of the attachment element relative to the implant body can be very precisely predefined, for example subject only to the measurement imprecision of manufacturing tolerances in the production of the attachment element. The connection element ensures the secure positioning and fixing of the attachment element abutment surface against the implant body abutment surface.

The attachment element may be in particular a gingiva former, an impression post, an abutment structure, a covering or a cover screw which, as has been described above, are made available to the dentist at different stages of treatment, from inserting the implant into the jaw to arranging the tooth replacement on an abutment structure that is provided to connect to the implant body.

The connection element for connecting the attachment element to the implant body is preferably a screw. However, in addition to other conceivable connection elements, it can also be a threaded piece which is mounted, worked or moulded integrally on the attachment element.

Furthermore, in the dental implant arrangement according to the embodiments described herein, the seal/sealing system may include a sealing element and a sealing seat. Advantageously, the sealing seat is either arranged in the attachment element or implant body, i.e. either in the first or as part of the first or second sealing surface. The seal introduced into the sealing seat is dimensioned such that the interior of the implant body is sealed off from the environment. This prevents entry of microorganisms without the axial positioning of the attachment element with respect to the implant body thereby being adversely affected or modified.

In an advantageous embodiment of the dental implant arrangement according to the embodiments disclosed herein, provision is made that the seal is completely enclosed by the first sealing surface and the second sealing surface. In this way, the sealing system composed of a seal and of first and second sealing surface can be constructed in a particularly simple manner, and the tightness can be defined by the nature or shape of the seal.

It is particularly advantageous if the sealing element is an O-ring or a sealing ring with an approximately wedge-shaped cross section, and if the sealing seat is an annular groove whose cross-sectional surface area is adapted to the sealing element.

Thus, for example, cross-sectional surface areas for an O-ring can in particular be square, rectangular, arc-shaped or in the shape of a portion of an oval. Moreover, the cross sections of the O-ring itself are not necessarily circular and instead can also be oval or elliptic or have other shapes. In order to achieve a desired sealing action, the distance between the groove bottom and the groove opening is less than the diameter of the O-ring in the corresponding direction of said distance. In this way, the O-ring protrudes from the groove opening and is deformable, by the connection of the attachment element to the implant body, such that there is sufficient sealing against entry of microorganisms into the interior of the implant body. The distance between the first and second sealing surface can be structurally dimensioned accordingly.

The advantage of a sealing ring with a wedge-shaped cross section is that, by the insertion of the attachment element into the implant body or the connection to the implant body, the forces applied to the sealing ring are introduced areally, since either the first or the second sealing surface acts on a side surface of the sealing ring. The seal or sealing surface is advantageously enlarged.

It is moreover advantageous if, in the arrangement according to the embodiments disclosed herein, the shape of the sealing seat and the shape of the sealing element are adapted to each other such that an elastic deformation of the sealing element is ensured when implant body and attachment element are joined together, and if the sealing force is introduced axially and/or radially into the implant body and into the attachment element by the elastic deformation. An improved sealing action is thereby achieved.

Moreover, it is expedient if the sealing force can be applied by connecting the attachment element to the implant body.

In the arrangement according to the embodiments disclosed herein, provision is also made that a desired sealing force can be predefined by the choice of material of the sealing element and/or by the adaptation of the size and/or shape of the sealing seat to the sealing element and/or by the adaptation of the size or shape of the sealing element to the sealing seat. In this way, the arrangement acquires a high degree of structural freedom since the sealing force is predefinable, in particular by a possible combination of choice of material, size and shape both of the sealing seat and also of the sealing element.

In this connection, provision is also made according to the embodiments disclosed herein, that the seal may be produced from polyether ether ketone or from polyether ketone ketone.

An advantageous development of the arrangement according to the embodiments disclosed herein is characterized in that the implant body and the attachment element can be connected to each other with form-fit engagement, such that a rotation of the implant body takes place during a rotation of the attachment element. In this way, the radial position of the attachment element relative to the implant body can be predefined. This position is independent of the procedure of connecting attachment element and implant body. The connection element alone, for example a screw, ensures a secure connection of the two structural elements.

A particularly advantageous embodiment of the arrangement according to the embodiments herein is characterized in that the implant body abutment surface may be configured as the implant body sealing surface and the attachment element abutment surface may be configured as the attachment element sealing surface, such that the interior of the implant body is sealed off from the environment.

In this way, two sealing systems are realized which achieve a particularly good overall sealing action. On the one hand, the sealing system composed of abutment surfaces that also serve as sealing surface can already ensure good sealing in order to prevent entry of microorganisms into the interior of the implant body. On the other hand, even in the event of micro-movements, the sealing element ensures that the interior of the implant body is protected from contamination with microorganisms. Micro-movements are, for example, those comparatively small radial movements of the attachment element with respect to the implant which, on account of forces caused by chewing or biting forces, act on the attachment element or on the arrangement of attachment element and implant body.

It is particularly advantageous if the implant body sealing surface is configured as a conically extending implant body sealing surface, which can be applied to the conically extending attachment element sealing surface in such a way that the interior of the implant body is sealed off from the environment. The sealing action in each of the two sealing systems is advantageously supported by the conical shapes. In this case, the force applied by the connection element is introduced into the implant body and the attachment element not only in the axial direction but instead both in the axial and radial directions. Accordingly, the sealing action also takes place in the axial and radial directions

In one or more embodiments herein, the implant body configured substantially as a hollow body is stabilized by the inserted attachment element and, for example, by a fastening screw extending therein and secured against possible deformation during the screwing into the jaw bone. This is advantageous particularly in the case of slender implant bodies of small diameter, since these may be damaged by the tension during the screwing-in procedure.

In one or more embodiments herein, provision is moreover made that the implant body sealing surface and the attachment element sealing surface each have two-part surfaces, namely a first and second implant body sealing surface and a first and a second attachment element sealing surface, that a grip portion of the attachment element is arranged axially between the first and the second attachment element sealing surface and sits with form-fit engagement in a receiving portion of the implant body which is arranged axially between the first and the second implant body sealing surface.

According to the embodiments disclosed herein, the conically extending sealing surfaces are placed sealingly on each other, wherein an axially upper sealing portion is separated from an axially lower sealing portion by a form-fit engagement portion.

In this way, a double cone is created which has two sealing portions structurally separated from each other. By means of two sealing portions, i.e. also an implant body abutment surface with two portions or an attachment element abutment surface with two portions, the sealing safety is as it were doubled and is additionally improved with a sealing element.

It is particularly advantageous if the implant body and/or the attachment element is produced from a ceramic or produced from a sintered material, which comprises 98-50% by volume of zirconium oxide as matrix, or produced from polyether ether ketone or produced from polyether ketone ketone.

In particular, it has been surprisingly observed that an implant body produced from a sintered material comprising 98-50% by volume of zirconium oxide as matrix can be screwed together with a gingiva former as a whole into a jaw bone without the implant body breaking. Moreover, it has been observed that such an implant body, which itself has a relatively rough and porous surface, nonetheless has a sealing surface that can be placed sealingly onto another sealing surface. On account of their favourable material properties, the plastics polyether ether ketone (PEEK) or polyether ketone ketone (PEKK) are also suitable for the production of the implant body which, in the aforementioned manner, can have sealing surfaces that can be placed sealingly on each other.

It has been surprisingly observed that such an implant body is mechanically stable enough to withstand a high torque load of more than 30 Ncm. Such high torques arise when an implant body with a thread is screwed into a jaw bone.

The following table lists elements of the illustrated embodiments of the disclosure and their associated reference numbers for convenience.

| Ref. No. | Element |
|---|---|
| 1, 1′, 1″, | implant body |
| 1″′ | |
| 2, 2′ | gingiva former |
| 3 | first implant body sealing surface as abutment surface |
| 4 | second implant body sealing surface as abutment surface |
| 5 | first gingiva former sealing surface as attachment element |
| | abutment surface |
| 6 | second gingiva former sealing surface as attachment element |
| | abutment surface |
| 7 | grip portion of the gingiva former |
| 8 | receiving portion of the implant body |
| 9 | impression post |
| 10 | receiving portion of the gingiva former |
| 11 | groove |
| 12 | spring |
| 13 | grip portion of the impression post |
| 14, 14′ | abutment as attachment element |
| 15 | first abutment sealing surface as attachment element abutment |
| | surface |
| 16 | second abutment sealing surface as attachment element |
| | abutment surface |
| 17 | grip portion of the abutment |
| 18 | tool |
| 19 | receiving vessel |
| 20 | outer thread |
| 21 | micro-thread |
| 22 | fastening screw as connection element |
| 24 | projection |
| D1 | O-ring sealing element |
| D2 | O-ring sealing element |
| D3 | sealing ring sealing element |
| D4 | sealing ring sealing element |
| D5 | O-ring sealing element |
| D6 | sealing ring sealing element |
| DS1 | first groove sealing seat |
| DS2 | second groove sealing seat |
| DS3 | third groove sealing seat |
| DS4 | fourth sealing seat |
| DS5 | fifth groove sealing seat |
| DS6 | sixth sealing seat |

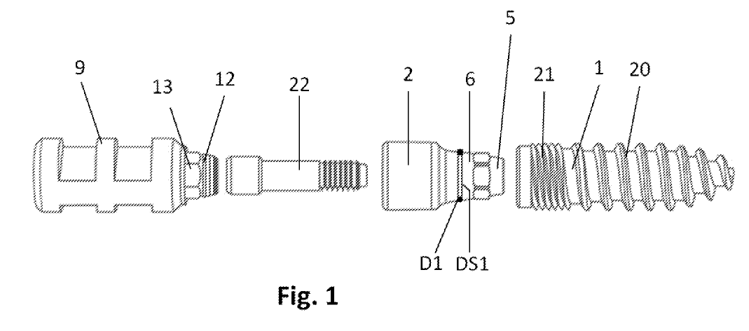

FIG. 1 shows a dental implant arrangement comprising an implant body 1 and gingiva former 2 (as an attachment element), wherein the implant body 1 is designed matching the gingiva former 2 in such a way that the gingiva former 2 is partially insertable (insertable to a predefined axial distance) into the implant body 1, wherein the implant body 1 and the gingiva former 2 can be connected to each other with form-fit engagement such that a rotation of the implant body 1 takes place during a rotation of the gingiva former 2. Note that, in addition to a gingiva former (e.g., gingiva former 2), an attachment element herein may take the form of generally any suitable dental implant attachment piece, such as e.g., an impression post, an abutment structure, a covering or a cover screw.

With continuing reference to the embodiment shown in FIG. 1, gingiva former 2 has a first conically extending gingiva former sealing surface 5 (also functioning as an abutment surface) and a second conically extending gingiva former sealing surface 6 of the gingiva former 2 (also functioning as an abutment surface), which can be applied to corresponding conically extending sealing surfaces on the implant body 1, wherein the abutment surfaces of the implant body 1, which are likewise configured as sealing surfaces in the embodiment shown, are not depicted in FIG. 1 and are explained in more detail with reference to a subsequent figure. Note that an abutment surface in the embodiments described herein may generally also serve as a sealing surface in the embodiments, and the terms are used interchangeably herein unless context otherwise suggests. In general, an abutment surface may also serve as a sealing surface when it provides (alone or in combination with one or more additional sealing surfaces or elements) a seal sufficient to ensure that the interior of the implant body is protected from contamination with microorganisms when compressed against a corresponding sealing surface or element with sufficient force.

Referencing FIG. 1 still, a first O-ring D1 is shown that serves to function as a sealing element. In general, a sealing element herein may comprise generally any mechanical seal component that, when compressed against a corresponding surface, serves to provide (alone or in combination with one or more additional sealing elements or sealing surfaces) a seal sufficient to ensure that the interior of the implant body is protected from contamination with microorganisms when compressed against a corresponding sealing surface or element with sufficient force. As shown in FIG. 1, O-ring D1 is a sealing element with a circular cross section that is seated in a sealing seat DS1. In general, a sealing seat as used herein may be any seat configured to receive a corresponding sealing element in a manner to provide sufficient stability and seal. In this embodiment, sealing seat DS1 is a first groove having a semicircular cross section. At its apical end, the implant body 1 has an outer thread 20 and, adjoining this in the direction of the distal end, an outer micro-thread 21.

With continuing reference to FIG. 1, the implant body 1 can be connected to the components described here by a fastening screw 22 as connection element. The implant body 1 may be produced from a sintered material, which comprises 98-50% by volume of zirconium oxide as matrix. Specifically, the implant body 1 may be produced from a material as described in the documents EP 2 086 908 B1 and EP 2 089 909 B1. Besides this explicit ceramic material, other ceramic materials, metals, metal alloys or plastics may be used for the implant body 1 or the gingiva former 2 as attachment element.

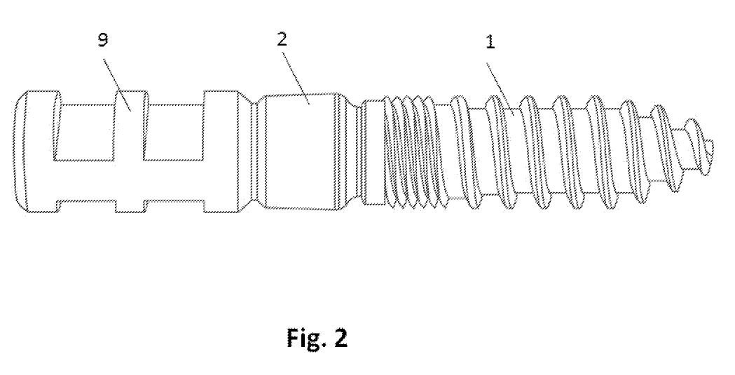

FIG. 2 shows the arrangement according to FIG. 1 in the assembled state.

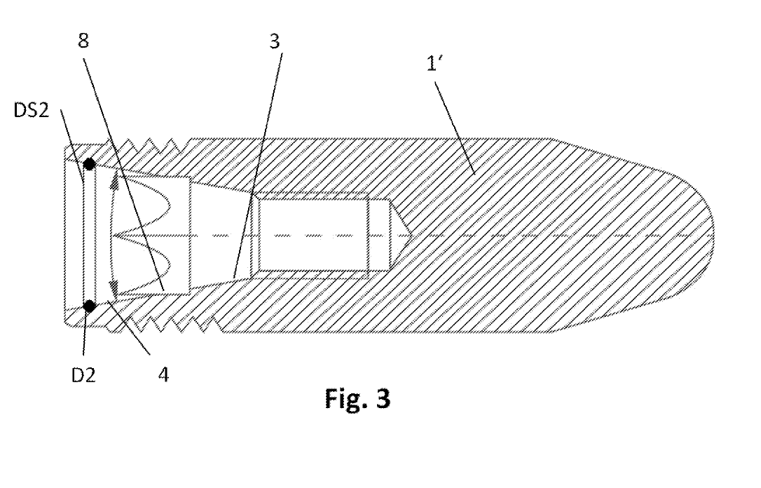

FIG. 3 shows implant body 1′. As shown, implant body 1′ has a first conically extending implant body sealing surface 3 (also serving as an abutment surface) and a second conically extending implant body sealing surface 4 (also serving as an abutment surface). As shown, implant body sealing surfaces 3 and 4 are configured to each correspond to a first and second conically extending gingiva former sealing surfaces, respectively (e.g., sealing surfaces 5 and 6, shown in FIG. 1), in a manner that the interior of the implant body 1′ is sealed off from the environment when the corresponding surfaces are compressed together, wherein a grip portion 7 (see FIGS. 1 & 4) of the gingiva former 2 is arranged axially between the first and the second gingiva former sealing surfaces (e.g., sealing surfaces 5, 6) and sits with form-fit engagement in a receiving portion 8 of the implant body 1 arranged axially between the first and the second implant body sealing surfaces 3, 4. In contrast to the implant body 1 from FIG. 1, which is not necessarily configured with a sealing element (e.g., an O-ring sealing element), the implant body 1′ includes a sealing element (second O-ring D2). In this example, sealing element D2 has an oval cross section, which is arranged in sealing seat DS2. Here, DS2 is configured as a sealing seat with a cross section in the shape of a portion of an oval. In this illustrative embodiment, the abutment surfaces and the attachment element abutment surfaces are configured as sealing surfaces, such that a predefinable sealing action is obtained between a respective abutment surface/attachment element abutment surface arrangement, without a separate seal being arranged here between the respective said surface arrangement. In this way, the abutment surface and the attachment element abutment surfaces perform both the function of a limit stop and also the function of a seal. Overall, then, in this exemplary embodiment the dental implant arrangement thus has three seals (the seal formed by corresponding sealing surfaces when they abut each other, and the seal formed by the sealing element when abutting the corresponding surface), which results in a particularly good and advantageous sealing action.

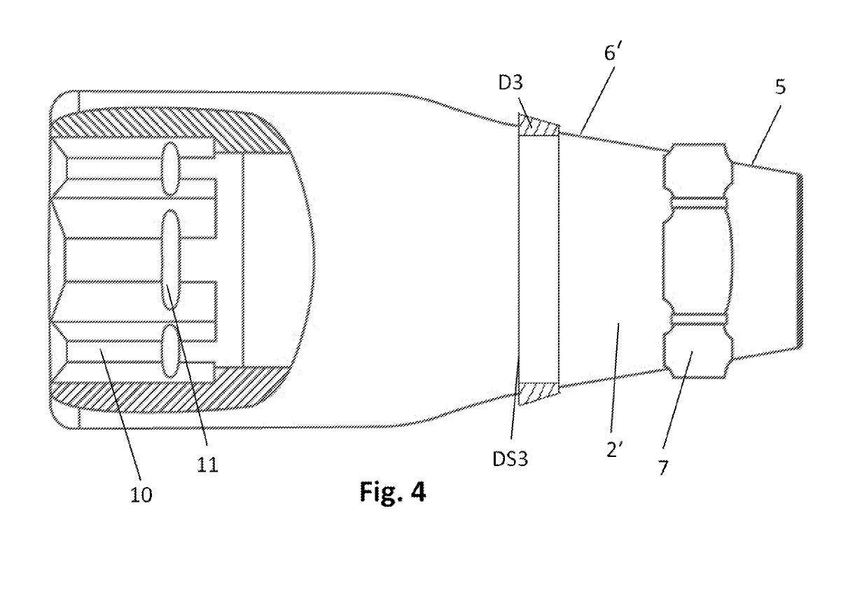

FIG. 4 shows gingiva former 2′, another exemplary embodiment of an attachment element. As shown, in the region of the second attachment element sealing surface 6′, a sealing ring D3 as a sealing element with a wedge-shaped cross section is arranged in groove DS3 as sealing seat with a triangular cross section. In this embodiment variant, the implant body 1 provided for this arrangement does not have a sealing seat or seal element in the region of its second implant body sealing surface (not shown). Also, although in this embodiment variant, sealing ring D3 and groove DS3 are located at the distal end of the second attachment element sealing surface 6′, in other embodiment variants sealing ring D3 and groove DS3 may be located in generally any location along first or second attachment element sealing surfaces 5 or 6′. Accordingly, in this embodiment, the third groove DS3 acts as a first abutment/sealing surface which lies opposite a second abutment/sealing surface on the implant body 1 (not shown), wherein the first sealing surface is a portion of the first or second gingiva former sealing surfaces. The first and second gingiva former sealing surfaces, together with the first sealing ring D3, together with the corresponding implant body surfaces, are together a seal or a sealing system, which seals off the interior of the implant from the environment.

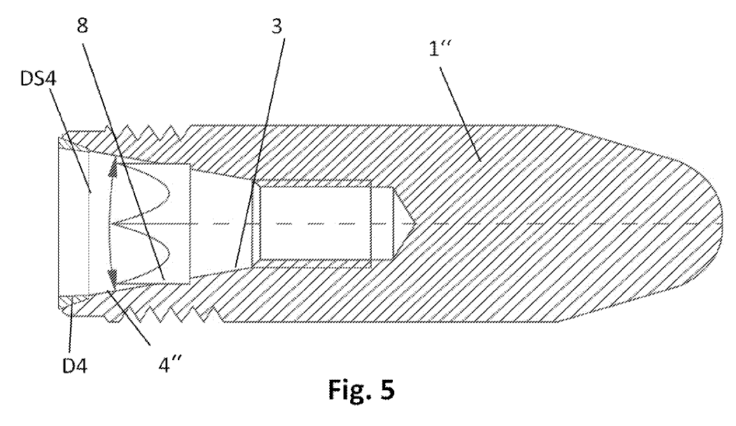

A further exemplary embodiment of a sealing system for an implant body 1″ is shown in FIG. 5. Here, sealing ring D4 as sealing element is arranged in a fourth sealing seat DS4. In this exemplary embodiment, sealing ring D4 is arranged at the front end of the implant body facing towards the attachment element (the distal end of the implant body 1″) and protrudes past the front end thereof. Sealing seat DS4 is configured as a bevel on the front-end recess of the implant body 1″. This has the effect that, upon partial insertion of the attachment element into the implant body 1″, sealing ring D4 is pressed into the fourth sealing seat DS4 and against the corresponding attachment element surface.

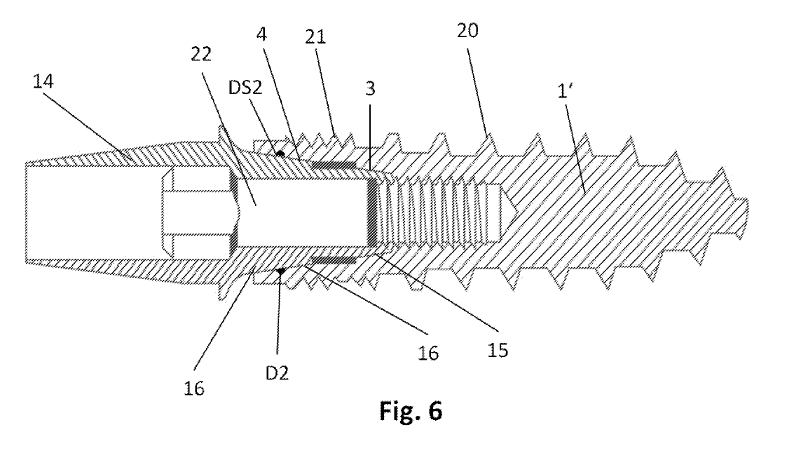

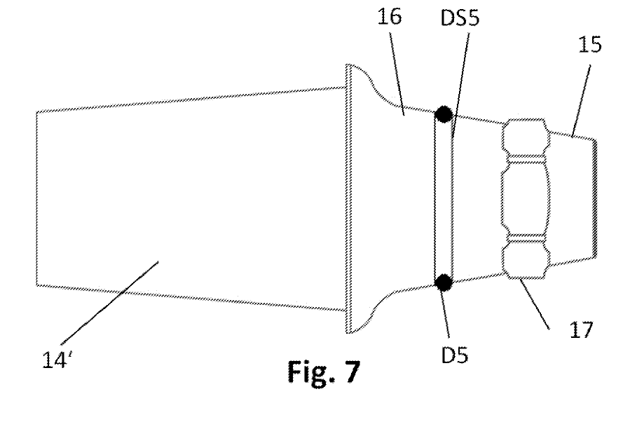

FIGS. 6 and 7 show that, additionally or alternatively to the gingiva former 2, an abutment structure 14, 14′ is provided as attachment element which is partially insertable into the implant body 1′, wherein the implant body 1′ and the abutment structure 14, 14′ can be connected to each other with form-fit engagement, wherein the implant body 1′ has a first and a second conically extending implant body sealing surface 3, 4, which can each bear on a first conically extending abutment sealing surface 15 and a second conically extending abutment sealing surface 16 of the abutment structure 14, 14′ in such a way that the interior of the implant body 1′ is sealed off from the environment, wherein a grip portion 17 of the abutment structure 14, 14′ is arranged axially between the first and the second abutment sealing surface 15, 16 and sits with form-fit engagement in the receiving portion 8 of the implant body 1′. In this example too, the abutment sealing surfaces 15, 16 are configured as attachment element abutment surfaces and at the same time as sealing surfaces.

The receiving portion 8 of the implant body 1 and the receiving portion 10 of the gingiva former 2 may be configured as hexagonal inner contours into which a hexagonal grip portion 7 of a gingiva former 2, a grip portion 17 of an abutment structure 14, 14′, a grip portion 13 of an impression post 9 and/or a grip portion of a tool 18 can be inserted with form-fit engagement.

FIG. 6 also shows O-ring D2 in its second groove DS2. In this example, the second groove DS2 acts as a first sealing surface which, together with a second sealing surface (namely, the surface portion on the conically extending second abutment sealing surface 16 lying opposite the second groove DS2), completely encloses the O-ring D2. The diameter of the O-ring D2 is dimensioned such that, when assembly to the attachment element has not yet taken place, O-ring D2 protrudes past the second implant body sealing surface 4. After the assembly, as shown in FIG. 6, the O-ring D2 is deformed in the elastic region of its material—in this exemplary embodiment, polyether ether ketone (PEEK) or alternatively polyether ketone ketone (PEKK)—such that the restoring forces of the deformation achieve a necessary sealing action, wherein the sealing forces act between the first and second sealing surface.

An alternative arrangement of a seal on the abutment structure 14′ is shown in FIG. 7, wherein O-ring D5 as a sealing element is arranged in a fifth groove DS5 as sealing seat on the second abutment sealing surface 16 in the abutment structure 14′.

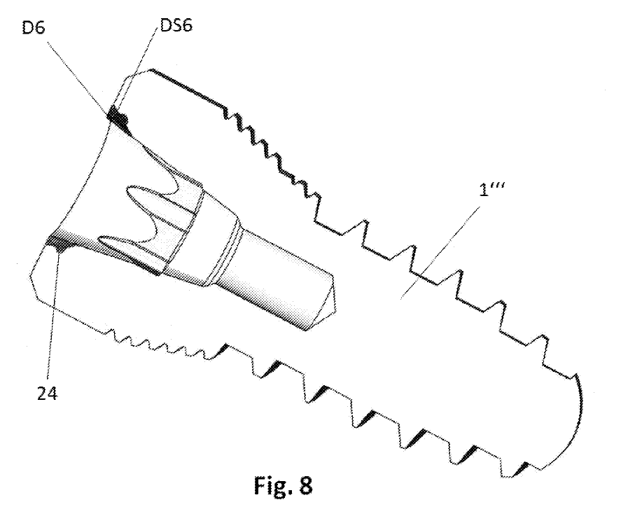

FIG. 8 shows one exemplary embodiment of a sealing system for an implant body—here, implant body 1′″. A sealing ring D6 as a sealing element is arranged in a sixth sealing seat DS6. A particular aspect of this arrangement is that the sealing ring D6, like the sealing ring D4, is also arranged at the distal/front end of the implant body 1′″ facing towards the attachment element and protrudes beyond the front end thereof. In addition, this arrangement has a projection 24 which is arranged on the side of the sealing ring D6 bearing on the implant body 1′″. The sixth sealing seat DS6 is correspondingly configured as a bevel on the front-end recess of the implant body 1′″, wherein a recess is introduced into the surface of the bevel in order to receive the projection 24. This has the effect that the sealing ring D6 can be arranged in the sixth sealing seat DS6 at a position predefined by the recess, and the sealing ring D6 is also held at the position, for example upon insertion of an abutment structure. Moreover, during the partial insertion of the attachment element into the implant body 1′″, the sealing ring D6 then also presses into the sixth sealing seat DS6 and against the attachment element.

Unless the context clearly requires otherwise, throughout the description and the claims, words using the singular or plural number also include the plural or singular number respectively. Additionally, the words “herein,” “above,” “below” and words of similar import, when used in this application, refer to this application as a whole and not to any particular portions of this application. “Or” means “and/or.” Further, the conjunction “or” covers all of the following interpretations of the word: any of the items in the list, all of the items in the list and any combination of the items in the list. It should further be noted that the terms “first,” “second,” “primary,” “secondary,” and the like herein do not denote any order, quantity, or importance, but rather are used to distinguish one element from another.

The various embodiments described above are provided by way of illustration only and should not be construed to limit the scope of the disclosure. Those skilled in the art will readily recognize various modifications and changes that may be made to the principles described herein without following the example embodiments illustrated and described herein, and without departing from the spirit and scope of the disclosure. We therefore claim as our invention all that comes within the scope of these claims.

We claim:

1. A dental implant arrangement comprising:
an implant body having an implant body abutment surface and a first sealing surface;
an attachment element having an attachment element abutment surface and a second sealing surface; and
a connection element,
wherein the implant body is configured to correspond to the attachment element such that the attachment element is partially insertable into the implant body as far as the implant body abutment surface and wherein the second sealing surface is positioned opposite to the first sealing surface when the attachment element is inserted as far as the implant body abutment surface,
wherein either the first or second sealing surface has a sealing seat into which a sealing element is inserted, and
wherein the attachment element is connected to the implant body by the connection element, in a manner that the attachment element abutment surface is held against the implant body abutment surface, and the sealing element is held against the first or second sealing surface, such that the interior of the implant body is sealed off from the environment.

2. The arrangement as claimed in claim 1, wherein the attachment element is a gingiva former, an impression post, an abutment structure, or a cover screw.

3. The arrangement as claimed in claim 1, wherein the sealing element is completely enclosed by the first sealing surface and the second sealing surface.

4. The arrangement as claimed in claim 2, wherein the sealing element is completely enclosed by the first sealing surface and the second sealing surface.

5. The arrangement as claimed in claim 1, wherein the sealing element is an O-ring or a sealing ring with a substantially wedge-shaped cross section, and wherein the sealing seat is an annular groove whose cross section is adapted to the sealing element.

6. The arrangement as claimed in claim 2, wherein the sealing element is an O-ring or a sealing ring with a substantially wedge-shaped cross section, and wherein the sealing seat is an annular groove whose cross section is adapted to the sealing element.

7. The arrangement as claimed in claim 3, wherein the sealing element is an O-ring or a sealing ring with a substantially wedge-shaped cross section, and wherein the sealing seat is an annular groove whose cross section is adapted to the sealing element.

8. The arrangement as claimed in claim 1, wherein the shape of the sealing seat and the shape of the sealing element are adapted to each other such that an elastic deformation of the sealing element is ensured when the implant body and the attachment element are connected together, and wherein a sealing force is introduced axially and/or radially into the implant body and into the attachment element by the elastic deformation.

9. The arrangement as claimed in claim 2, wherein the shape of the sealing seat and the shape of the sealing element are adapted to each other such that an elastic deformation of the sealing element is ensured when the implant body and the attachment element are connected together, and wherein a sealing force is introduced axially and/or radially into the implant body and into the attachment element by the elastic deformation.

10. The arrangement as claimed in claim 8, wherein the sealing force can be applied by connecting the attachment element to the implant body.

11. The arrangement as claimed in claim 8, wherein a desired sealing force can be predefined by the choice of material of the sealing element or by the adaptation of the size or shape of the sealing seat to the sealing element or by the adaptation of the size or shape of the sealing element to the sealing seat.

12. The arrangement as claimed in claim 10, wherein a desired sealing force can be predefined by the choice of material of the sealing element or by the adaptation of the size or shape of the sealing seat to the sealing element or by the adaptation of the size or shape of the sealing element to the sealing seat.

13. The arrangement as claimed in claim 1, wherein the sealing element is produced from polyether ether ketone or from polyether ketone ketone.

14. The arrangement as claimed in claim 2, wherein the sealing element is produced from polyether ether ketone or from polyether ketone ketone.

15. The arrangement as claimed in claim 1, wherein the implant body and the attachment element are configured to be connected to each other with form-fit engagement, such that a rotation of the attachment element causes rotation of the implant body.

16. The arrangement as claimed in claim 1, wherein the implant body abutment surface is configured as an implant body sealing surface and the attachment element abutment surface is configured as an attachment element sealing surface.

17. The arrangement as claimed in claim 16, wherein the implant body sealing surface is configured as a conically extending implant body sealing surface and the attachment element sealing surface is configured as a conically extending attachment element sealing surface.

18. The arrangement as claimed in claim 16, wherein the implant body sealing surface and the attachment element sealing surface are each configured as two part-surfaces, namely a first and second implant body sealing surface and a first and a second attachment element sealing surface, and wherein a grip portion of the attachment element is located axially between the first and the second attachment element sealing surfaces and sits with form-fit engagement in a receiving portion of the implant body which is located axially between the first and the second implant body sealing surfaces.

19. The arrangement as claimed in claim 17, wherein the implant body sealing surface and the attachment element sealing surface are each configured as two part-surfaces, namely a first and second implant body sealing surface and a first and a second attachment element sealing surface, and wherein a grip portion of the attachment element is located axially between the first and the second attachment element sealing surfaces and sits with form-fit engagement in a receiving portion of the implant body which is located axially between the first and the second implant body sealing surfaces.
